(19) United States
(12) Patent Application Publication
(10) Pub. No.: US 2018/0061569 A1
(43) Pub. Date: Mar. 1, 2018

(54) METHODS OF MANUFACTURE OF AN INDUCTIVE COMPONENT AND AN INDUCTIVE COMPONENT

(71) Applicant: Analog Devices Global, Hamilton (BM)

(72) Inventors: Jan Kubík, Limerick (IE); Bernard Patrick Stenson, Limerick (IE); Shane Patrick Geary, Clare (IE); Michael Noel Morrissey, Limerick (IE)

(73) Assignee: Analog Devices Global, Hamilton (BM)

(21) Appl. No.: 15/248,775

(22) Filed: Aug. 26, 2016

(51) Int. Cl. H01F 41/04; H01F 41/02; H01F 27/28; H01F 1/03

(52) U.S. Cl. CPC H01F 41/041; H01F 1/0315; H01F 27/2804; H01F 41/0206

(57) ABSTRACT

The disclosure relates to the manufacture of inductive components, in particular transformers, using a combination of microfabrication techniques and discrete component placement. By using a prefabricated core, the core may be made much thicker than one that is deposited using microfabrication techniques. As such, saturation occurs later and the efficiency of the transformer is improved. This is done at a much lower cost than the cost of producing a thicker core by depositing multiple layers using microfabrication techniques.

### FIELD OF THE DISCLOSURE

The present disclosure relates to an inductive component and a method of manufacturing an inductive component. In particular, the disclosure relates to the manufacture of a transformer using microfabrication techniques and the use of a discrete core.

### BACKGROUND

Inductive components include inductors and transformers. Transformers are used in electronic circuits for two main purposes. Firstly, they are used for the transfer of data from one part of a circuit to another. Secondly, they are used to transfer power. One advantage of using a transformer is that transformers provide galvanic isolation between the different parts of the circuit. Transformers typically include a first winding that may act as an input, and a second winding that may act as an output. A signal in the first winding generates a magnetic field which in turn creates a magnetic flux in the transformer core. This in turn generates a magnetic field which induces a current in the secondary winding. Depending on the application, transformers have different types of cores. For example, an isolation transformer may have an air core. Alternatively, to increase the power that may be transferred between the two parts of the circuit, a magnetic core may be used.

The drive towards ever smaller components in electronic circuits has led to the development of integrated transformers using microfabrication techniques. This enables transformers to be produced as integrated circuits on silicon wafers. In integrated transformers, the windings are deposited on the silicon wafer, and are isolated from each other using polymide. Such transformers provide galvanic isolation for voltages of up to 400 volts, and are beneficial for data transfer.

In addition to data transfer, there is also a need to use transformers for power transfer. However typical integrated transformers only achieve efficiencies of about 25-30%. As such, integrated transformers have also been produced in which a magnetic core is also deposited on the silicon wafer. Such transformers may achieve an efficiency of up to 50%.

As deposited cores have a relatively low volume, they tend to saturate fairly early, and the maximum power that can be handled for a winding of a given area is relatively low. There is a reluctance to increase the volume of cores that are deposited, because depositing material in this way is very expensive in time and cost. As such, there is a need for integrated transformers with an improved maximum power rating that can be produced in a short time frame, and for little cost.

### SUMMARY OF THE DISCLOSURE

The methods and devices of the described technology each have several aspects, no single one of which is solely responsible for its desirable attributes.

The disclosure relates to the manufacture of inductive components, in particular transformers, using a combination of microfabrication techniques and discrete component placement. By using a prefabricated core, the core may be made much thicker than one that is deposited using microfabrication techniques. As such, saturation occurs later and the efficiency of the transformer is improved. This can be done at a much lower cost than the cost of producing a thicker core by depositing multiple layers using microfabrication techniques.

In a first aspect, the present disclosure provides a method of manufacturing an inductive component, comprising: providing a substrate; forming at least a portion of one or more windings on the substrate using microfabrication techniques to form a winding structure, placing at least a first part of a discrete ferromagnetic core on or adjacent a first side of the at least a portion of one or more windings, wherein the first part of the discrete ferromagnetic core is prefabricated.

In a second aspect, the present disclosure provides a method of manufacturing an inductive components in which a winding structure is provided using microfabrication techniques and a discrete core is positioned on or around the winding structure.

In a third aspect, the present disclosure provides an inductive component, comprising: one or more windings, at least portions of which are formed using microfabrication techniques; a discrete ferromagnetic core positioned on or around the one or more windings.

Further features of the present disclosure are defined in the appended claims.

### BRIEF DESCRIPTION OF THE DRAWINGS

The present disclosure will now be described, by way of non-limiting example only, with reference to the accompanying drawings, in which:

FIG. 1 is a perspective view of a transformer according to an embodiment of the disclosure;

FIG. 2 is an end view of the transformer shown in FIG. 1;

FIGS. 3A to 3J show the process of manufacturing the transformer shown in FIG. 1;

FIG. 4 is an end view of a transformer according to an embodiment of the disclosure;

FIG. 5 is a perspective view of a transformer according to an embodiment of the disclosure;

FIG. 6 is an end view of the transformer shown in FIG. 5;

FIG. 7 is a perspective view of a transformer according to an embodiment of the disclosure;

FIG. 8 is an end view of the transformer shown in FIG. 7;

FIGS. 9A to 9I show the process of manufacturing the transformer shown in FIG. 7;

FIG. 10 is an end view of a transformer according to an embodiment of the disclosure; and

FIG. 11 is a chart showing the inductance of the transformer shown in FIG. 4.

### DETAILED DESCRIPTION

Various aspects of the novel systems, apparatuses, and methods are described more fully hereinafter with reference to the accompanying drawings. Aspects of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of or combined with any other aspect. For example, an apparatus may be implemented or a method may be practiced using any number of the aspects set forth herein. In addition, the scope is intended to encompass such an apparatus or method which is practiced using other structure, functionality, or structure and functionality in addition to or other than the various aspects set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to a variety of systems. The detailed description and drawings are merely illustrative of the disclosure rather than limiting, the scope of the disclosure being defined by the appended claims and equivalents thereof.

The present disclosure provides a transformer in which the windings are produced by depositing them on a silicon substrate, and in which the core is prefabricated before being located in or around the windings using pick and place manufacturing techniques. This has various advantages when compared with forming a core using microfabrication techniques such as deposition. For example, providing a thicker core is easier and less expensive than building up a core using deposition to form multiple layers. A thicker core saturates later than a thinner core and is therefore operable at higher powers.

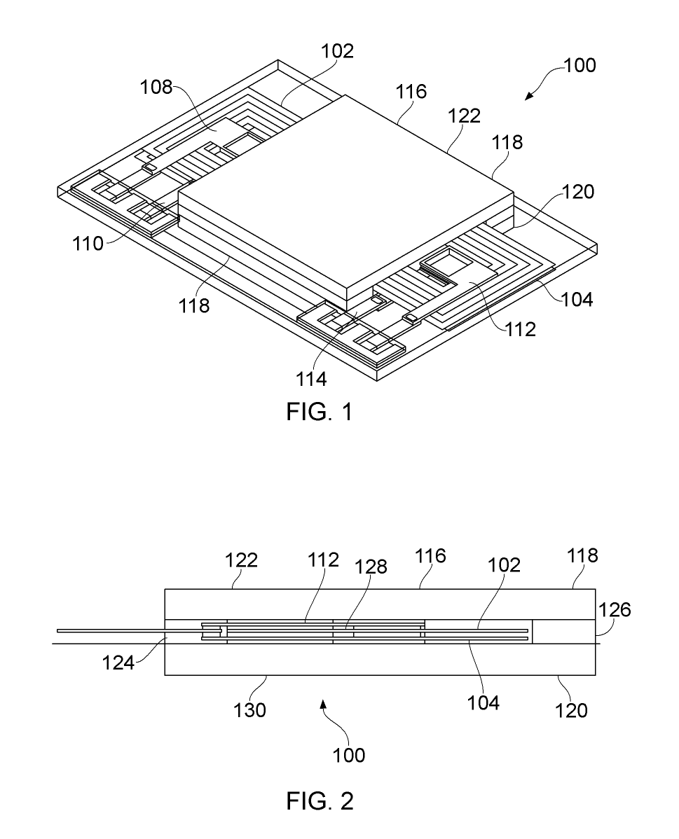

FIG. 1 is a perspective view of a transformer 100 in accordance with an embodiment of this disclosure. FIG. 2 shows an end-view of the transformer 100. The transformer includes a primary winding 102 and a secondary winding 104. Both windings consist of metal tracks, typically formed using impulse plasma deposition, on several insulting layers. The metal is typically aluminum, and the insulator is typically formed on a silicon substrate. In FIGS. 1 and 2, the substrate and the insulating layers are omitted for clarity. The metal tracks of each winding form a six-turn elongate rectangular spiral. The windings 102, 104 are arranged in parallel planes, separated by a layer of insulting material. The windings are also aligned in the vertical direction. The primary winding 102 is uppermost in FIGS. 1 and 2, and the secondary winding 104 is lowermost. As such, in FIG. 1 the majority of the upper surface of the primary winding 102 may be seen. Conversely, very little of the secondary winding 104 may be seen. The windings also form an opening (which is obscured by the magnetic core, described in greater detail below). Each winding is provided with circuit connections. The primary winding 102 is coupled to primary circuit connections 108 and 110. The secondary winding 104 is coupled to secondary circuit connections 112 and 114.

The primary and secondary windings 102, 104 may have a length of between 2 mm and 3 mm, for example, 2.6 mm. The windings may have a width of between 0.5 mm and 1.5 mm, for example, 1 mm. The opening in the windings may have a length of between 1 mm and 2 mm, for example, 1.4 mm. The opening may have a width of between 0.2 mm and 0.5 mm, for example, 0.3 mm. The conductive tracks forming the windings may have a width of around 8 μm and the spacing between the primary and secondary windings may be 8 μm.

The transformer 100 also includes a magnetic core 116. The magnetic core 116 is prefabricated in two parts. The core 116 includes an upper part 118 and a lower part 120. The upper part includes an upper cuboid section 122 and three protruding sections. In particular, the upper part 118 includes end protrusions 124 and 126, and middle protrusion 128. The protrusions are elongate and extend the full length of the upper cuboid section 122. The lower part 120 includes a lower cuboid section 130. The upper and lower cuboids 122, 130 are the same size and shape. The upper cuboid section 122 is positioned above the windings. The lower cuboid section 130 is positioned below the windings.

Each cuboid section has a thickness of approximately 100 micrometres and has a length approximately equal to the length of the opening in the middle of the primary and secondary windings 102, 104. Each cuboid section 122, 130 is wide enough to extend beyond the edges of the windings by approximately 20 μm. The protrusions 124, 126, 128 have a depth of around 10 μm, which is sufficient to reach from the upper cuboid section 122 to the lower cuboid section 130 when the cuboids are in position around the windings 102, 104. The upper part 118 resembles an ‘E’ shape, whereas the lower part 120 resembles an ‘I’. As such, this arrangement is referred to as an E-I core. Further details of the manufacturing process are provided below. In FIGS. 1 and 2, the substrate and any insulating layers are omitted for clarity.

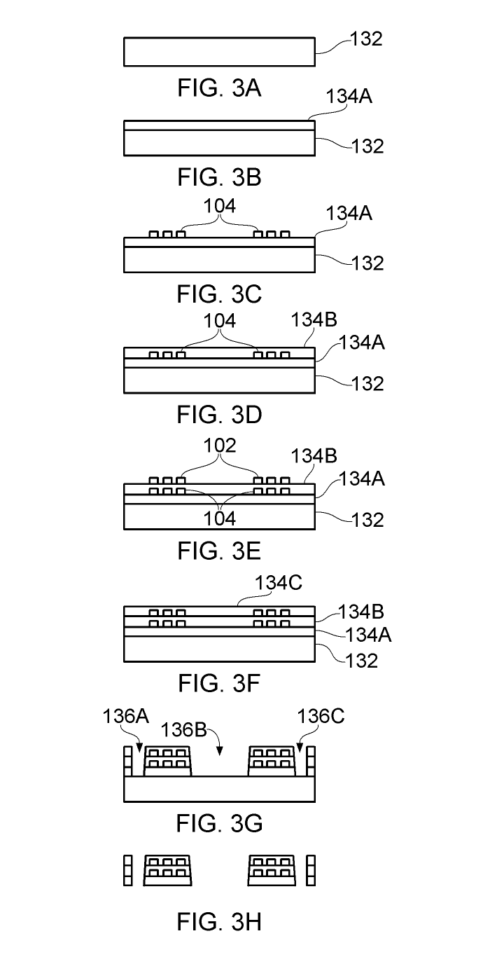

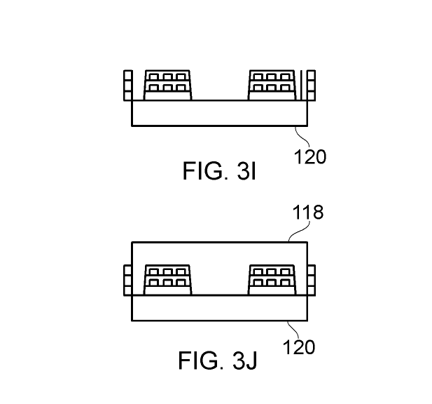

A method of manufacturing the isolation transformer 100 will now be described in connection with FIGS. 3A to 3J. FIGS. 3A to 3H illustrate formation of winding portions by microfabrication techniques, such as deposition, masking (such as a photolithography) and etching. The process begins with the provision of a silicon substrate 132, as shown in FIG. 3A. The silicon substrate 132 may be a silicon wafer used in the manufacture of semiconductors, and may have a thickness of approximately 200 μm. A layer of insulating material 134A is then deposited on the upper surface of the silicon, as shown in FIG. 3B. The secondary winding 104 is then deposited using impulse plasma deposition (IPD) on the top surface of the insulating layer 134A, as shown in FIG. 3C. FIG. 3D shows the provision of a further insulating layer 134B. This process then repeats for the primary winding 102, as shown in FIGS. 3E and 3F. As such, the arrangement shown in FIG. 3F includes an upper insulating layer 134C which forms an upper surface of the structure.

In order for the structure to accept the magnetic core 116, holes can be formed in the insulating layers 134A to 134C. This is done using polymide and standard exposing, developing and curing techniques in order to form the openings 136A, 136B and 136C shown in FIG. 3G. Furthermore, as the final structure does not require the silicon substrate 132, the silicon substrate is removed using back grinding. Alternatively, a sacrificial layer may be provided between the silicon substrate 132 and the insulating layer 134A. The sacrificial layer is removed using a chemical etch in order to detach the silicon substrate. FIG. 3H shows the transformer 100 with the substrate 132 removed. The structure is supported by the fact that at either end of the transformer 100, there are no openings.

As noted above, the various components of the magnetic core 116 are prefabricated. The core 116 can be prefabricated and laminated or otherwise adhered to the portions that define windings, at least portions of which can be formed as described above with microfabrication techniques. The structure shown in FIG. 3H is placed on a lower portion 120 of the magnetic core 116, as shown in FIG. 3I. This may be done using a pick and place machine. Alternatively, the lower portion 120 of the magnetic core 116 may be placed underneath the structure shown in FIG. 3H, using a pick and place machine. The upper portion 118 of the magnetic core 116, having the protrusions noted above, is then placed on top of the structure, as shown in FIG. 3J. The arrangement shown in FIG. 3J is the completed transformer 100.

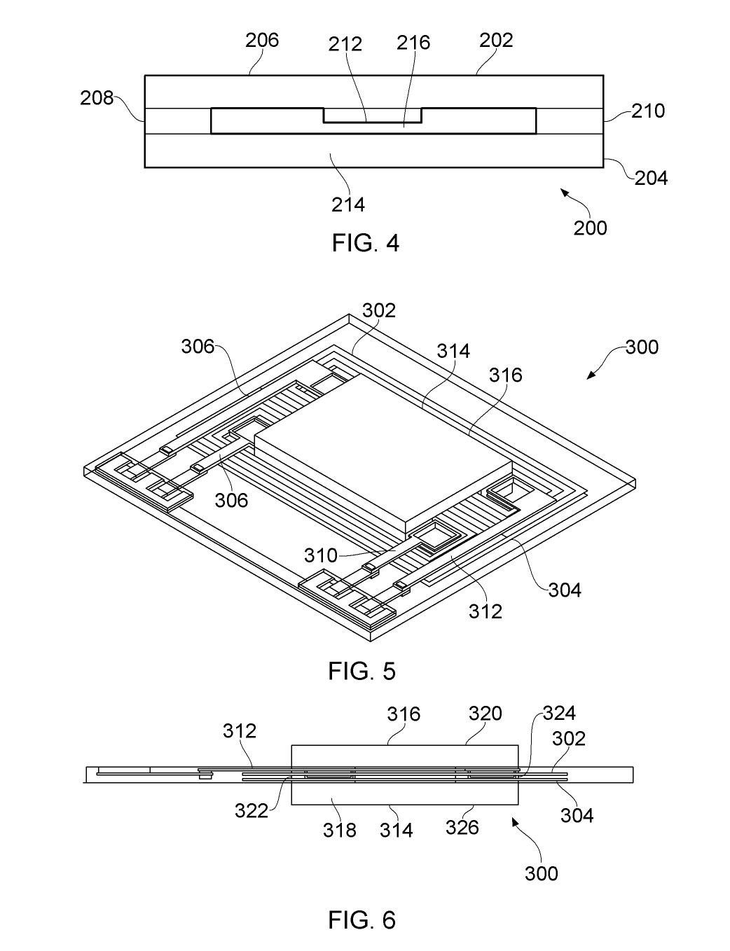

FIG. 4 is an end view of an alternative arrangement for the magnetic core. Magnetic core 200 essentially takes the same form as the magnetic core 116. In particular, the magnetic core 200 includes an upper part 202 and a lower part 204. The upper part 202 includes an upper cuboid section 206 and three protruding sections. In particular, the upper part 202 includes end protrusions 208 and 210, and middle protrusion 212. The protrusions are elongate and extend the full length of the upper cuboid section 206. The lower part 204 includes a lower cuboid section 214. The upper and lower cuboid sections 206, 214 are the same size and shape. The upper cuboid section 206 is positioned above the windings. The lower cuboid section 214 is positioned below the windings.

In the arrangement shown in FIG. 5, the middle protrusion 212 is shorter than the end protrusions 208 and 210. As such, an air gap 216 is formed between a lower surface of the middle protrusion 212 and the lower portion 204 of the magnetic core 200. The impact of changing the size of this air gap 216 on the performance of the transformer will be described in more detail below. The magnetic core 200 is manufactured in the same way as the magnetic core 116.

FIG. 5 shows a further embodiment of a transformer 300 in accordance with this disclosure. FIG. 6 is an end view of the isolation transformer 300. Transformer 300 includes a primary winding 302 and a secondary winding 304. In this embodiment, each winding is formed as a figure of eight. As such, two openings are provided between the windings. The primary winding 302 includes connectors 306 and 308. The second winding 304 includes connectors 310 and 312. The transformer 300 includes a magnetic core 314. Magnetic core 314 is similar to magnetic core 116. In particular, the magnetic core 314 includes an upper part 316 and a lower part 318. The upper part 314 includes an upper cuboid section 320. However, in contrast to magnetic core 116, the core 316 includes only two protrusions. In particular, the upper part 316 includes end protrusions 322 and 324. The protrusions are elongate and extend the full length of the upper cuboid section 320. The lower part 316 includes a lower cuboid section 326. The upper and lower cuboid sections 320, 326 are the same size and shape. The upper cuboid section 320 is positioned above the windings. The lower cuboid section 326 is positioned below the windings.

In contrast to the magnetic core 116, the upper and lower portions 316, 318 have a width which is approximately equal to the distance between the outer edges of each of the openings. As such, the core does not extend completely around the outer edges of the figure of eight windings, but rather extends only to the width of the openings themselves. The transformer 300 is manufactured in the same manner as isolation transformer 100.

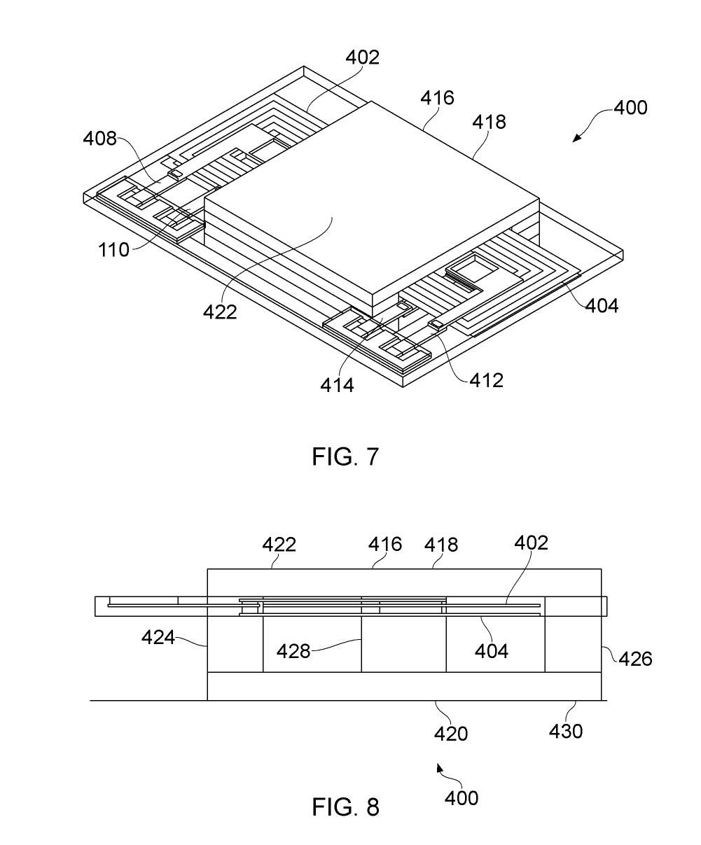

FIG. 7 is a perspective view of an isolation transformer 400 in accordance with a further embodiment of the present disclosure. FIG. 8 is an end view of the transformer 400. Transformer 400 is similar to isolation transformer 100. In particular, the transformer 400 includes a primary winding 402 and a secondary winding 404. As with FIGS. 1 and 2, in FIGS. 7 and 8 the substrate and the insulating layers are omitted for clarity. The metal tracks of each winding form a six-turn elongate rectangular spiral. The windings 402, 404 are arranged in parallel planes, separated by a layer of insulting material. The windings are also aligned in the vertical direction. The primary winding 402 is uppermost in FIGS. 7 and 8, and the secondary winding 404 is lowermost. The windings also form an opening (which is obscured by the magnetic core, described in greater detail below). Each winding is provided with circuit connections. The primary winding 402 is coupled to primary circuit connections 408 and 410. The secondary winding 404 is coupled to secondary circuit connections 412 and 414.

The dimensions of the windings 402, 404 may be the same as the dimensions noted above in connection with windings 102, 104.

The transformer 400 also includes a magnetic core 416. The magnetic core 416 is prefabricated in two parts. The core 416 includes an upper part 418 and a lower part 420. The upper part includes an upper cuboid section 422 and three protruding sections. In particular, the upper part 418 includes end protrusions 424 and 426, and middle protrusion 428. The protrusions are elongate and extend the full length of the upper cuboid section 422. The lower part 420 includes a lower cuboid section 430. The upper and lower cuboids 422, 430 are the same size and shape. The upper cuboid section 422 is positioned above the windings. The lower cuboid section 430 is positioned below the windings.

The magnetic core 416 differs from magnetic core 116 in that a gap is formed between the lower portion 420 of the magnetic core and the lower surface of the winding structure. This gap is to accommodate a silicon substrate. The protrusions 424, 426, 428 are each approximately 200 μm in depth, providing a gap sufficient to accommodate a silicon substrate. The silicon substrate is not shown in FIGS. 7 or 8.

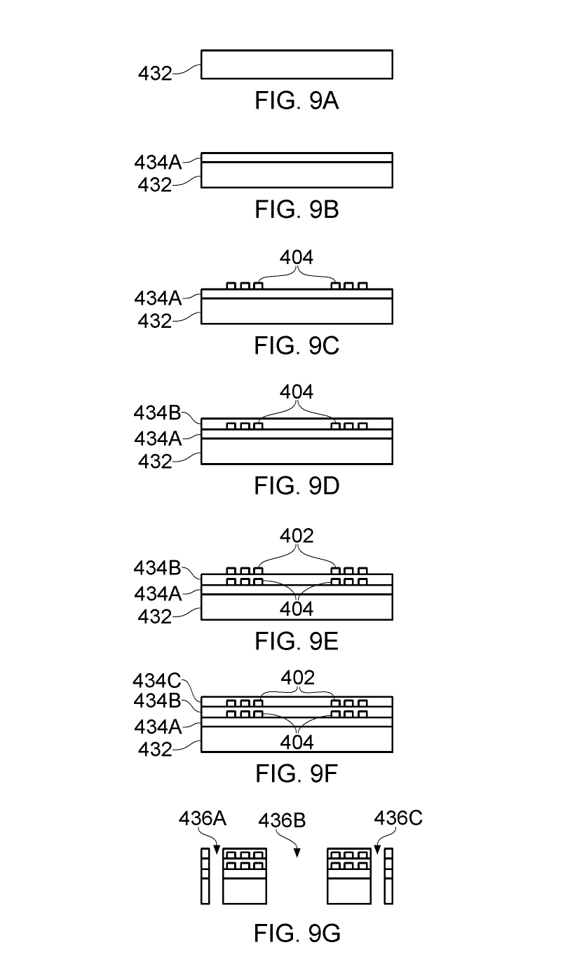

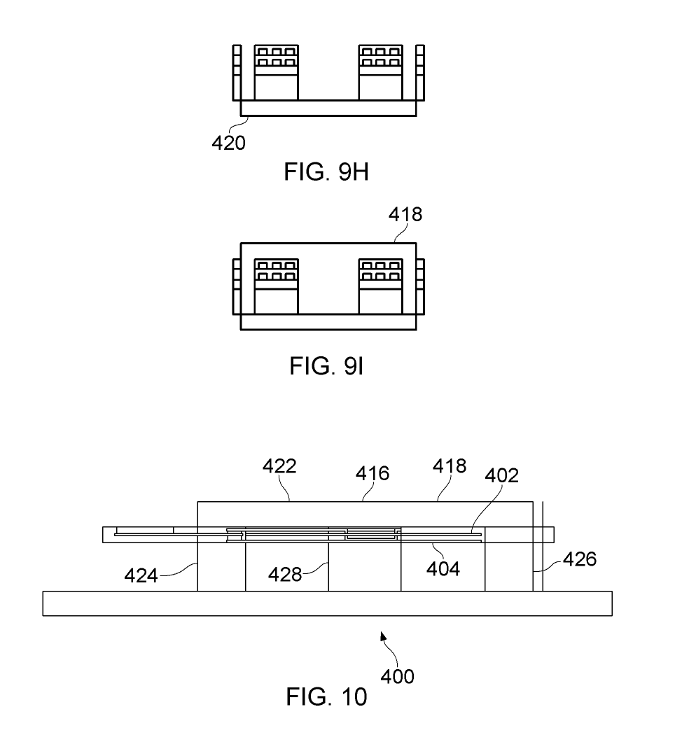

A method of manufacturing the isolation transformer 400 will now be described in connection with FIGS. 9A to 9J. FIGS. 9A to 9G illustrate formation of winding portions by microfabrication techniques, such as deposition, masking and etching. The process begins with the provision of a silicon substrate 432, as shown in FIG. 9A. The silicon substrate 432 may be a silicon wafer used in the manufacture of semiconductors, and may have a thickness of approximately 200 μm. A layer of insulating material 434A is then deposited on the upper surface of the silicon 432, as shown in FIG. 9B. The secondary winding 404 is then deposited using impulse plasma deposition (IPD) on the top surface of the insulating layer 434A, as shown in FIG. 9C. FIG. 9D shows the provision of a further insulating layer 434B. This process then repeats for the primary winding 402, as shown in FIGS. 9E and 9F. As such, the arrangement shown in FIG. 9F includes an upper insulating layer 434C which forms an upper surface of the structure.

In order for the structure to accept the magnetic core 416, holes can be formed in the insulating layers 134A to 134C and in the substrate 432. This is done using polymide and standard exposing, developing and curing techniques in order to form the openings 436A, 436B and 436C shown in FIG. 9G.

As noted above, the various components of the magnetic core 416 are prefabricated. The core 416 can be prefabricated and laminated or otherwise adhered to the portions that define windings, which can formed as described above with microfabrication techniques. The structure shown in FIG. 9G is placed on a lower portion 420 of the magnetic core 416, as shown in FIG. 9H. This may be done using a pick and place machine. Alternatively, the lower portion 420 of the magnetic core 416 may be placed underneath the structure shown in FIG. 9G, using a pick and place machine. The upper portion 418 of the magnetic core 416, having the protrusions noted above, is then placed on top of the structure, as shown in FIG. 9I. The arrangement shown in FIG. 9I is the completed transformer 400.

FIG. 10 shows an alternative arrangement for the magnetic core shown in FIGS. 7 and 8. In this example, a layer of ferromagnetic material 438 is provided on the underside of the substrate (not shown). As such, during manufacture, only the deposited winding arrangement and the upper portion of the magnetic core are placed on the substrate. This further simplifies the manufacturing process.

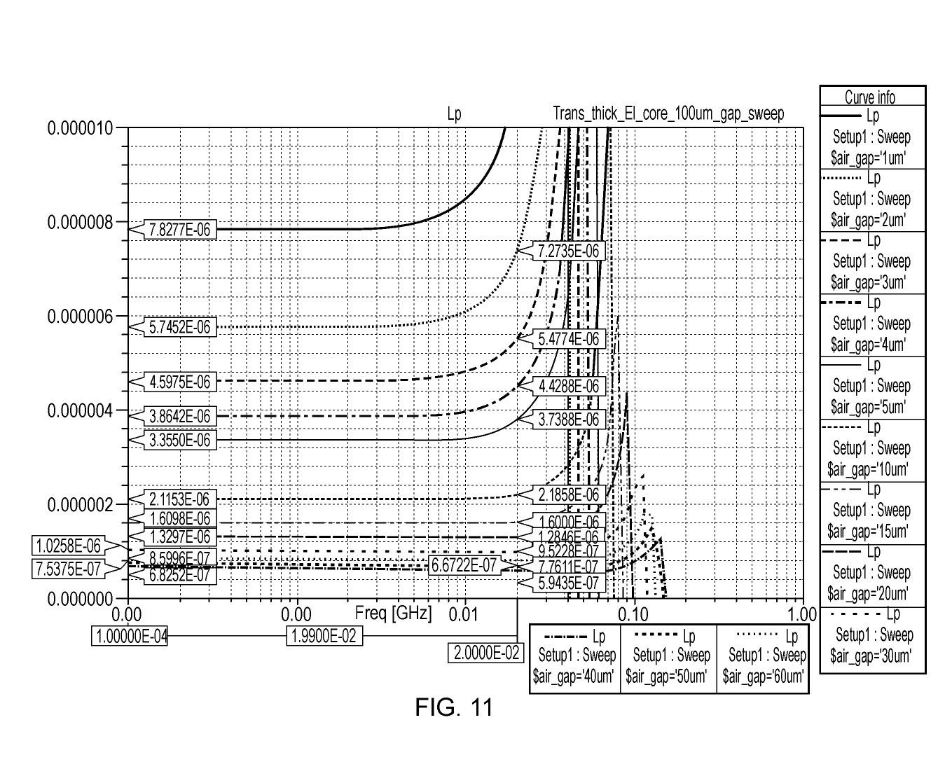

FIG. 11 is a chart showing the relationship between inductance and the air gap 216 shown in FIG. 4. As can be seen, the greater the gap, the lower the inductance. However, with a smaller gap, the core saturate earlier. As such, depending on the application, an appropriate air gap may be selected to achieve an appropriate balance of inductance and saturation.

In the above thick core examples, the core is prefabricated using isotropic materials. The core may be made from a ferromagnetic material such as Cobalt-Zirconium-Tantalum-Boron (CoZrTaB). A benefit of using CoZrTaB is that is has low coercivity, high electrical resistivity and an induced anisotropic field. The core is prefabricated by building up layers of CoZrTaB, which are insulated using layers of AlN, Al₂O₃ or SiO₂. This is to prevent eddy currents from forming in the core.

As an alternative to CoZrTaB, the core may be CoZrTaX (where X is another element). Alternative core materials include NiFe, CoFe, CoFeB and CoZrTa. Alternatively, the core may be a sintered ferrite-type material.

The discrete core may be manufactured using any known ferromagnetic manufacturing process. Typically this involves a process step and a fabrication step. The process step includes sub-steps of calcining, milling and spray drying. Fabrication may involve grinding, extrusion, pressing or injection molding. Any suitable fabrication technique may be used.

Table 1 shows the results of the characteristics of the above-noted transformers. Lp is the primary inductance. This was measured at low (0.1 MHz) and high (20 MHz) frequencies. This provides an indication of the energy that may be stored by the transformer. As can be seen, the primary inductance at low frequency and at high frequency is significantly better for the thick core transformers than for air core or thin core transformers. Additionally, the Q factor, which indicates the efficiency of storage, is also significantly greater for the thick core transformers. The k value, which represents the coupling coefficient (i.e. how much flux is coupled by the secondary winding), is also significantly higher for the thick core transformers. Finally, the inductance gain is also significantly greater for the thick core transformers.

TABLE 1

| | | | | | Induc- |
|---|---|---|---|---|---|
| | | | | | tance |
| | Lp (nH) @ | Lp (nH) @ | Q @ | K @ | gain @ |
| Result | 0.1 MHz | 20 MHz | 20 MHz | 20 MHz | 0.1 MHz |
| Air cored | 110 | 79 | 3.06 | 0.84 | 1.00 |
| Thin core | 454 | 425 | 11.09 | 0.95 | 4.13 |
| Thick core | 2115 | 2185 | 16.4 | 0.99 | 19.2 |
| (no | | | | | |
| substrate) - | | | | | |
| FIG. 1 | | | | | |
| Thick core | 2613 | 2584 | 37.3 | 0.99 | 19.7 |
| figure | | | | | |
| of eight | | | | | |
| winding - | | | | | |
| FIG. 5 | | | | | |
| Thick core | 2021 | 2185 | 33.5 | 0.99 | 18.4 |
| (with | | | | | |
| substrate) - | | | | | |
| FIG. 7 | | | | | |
| Thick core | 2072 | 2224 | 46.6 | 0.99 | 18.8 |
| (with | | | | | |
| substrate) - | | | | | |
| FIG. 10 | | | | | |

Using prefabricated ferromagnetic cores has various advantages. For example, by building the core separately, a much thicker core can be achieved, which saturates later than thinner cores, and which may achieve higher power densities. Furthermore, prefabricating a thick core is much cheaper than building a core in situ using deposition techniques.

In the above-described examples, the conductive tracks forming the windings have a thickness of approximately 10 μm. The upper and lower portions of the core have a thickness of approximately 100 μm. By using a prefabricated core, the core may therefore be around 10 times thicker than the windings.

In the above-described embodiments, the windings are shown as elongate planar spirals. This arrangement may be referred to as a “race track” arrangement. In the alternative, the above-described embodiments may be implements as square spirals, in which each section of each winding has the same length.

In the above-described embodiments, the substrate has be described as silicon. Alternatively, the substrate may be flex, printed circuit board (PCB) or glass.

As noted above, the above-described embodiments could be applied to an inductor, and hence to form an inductive component generally. Typically this would simply involve reduction in the number of coils to one, rather than two.

The claims presented herein are in single dependency format suitable for filing at the United States Patent & Trademark Office. However it is to be assumed that each one of the claims can be multiply dependent on any preceding claim except where that is technically unfeasible.

While disclosed in the context of a transformer, it will be appreciated that the inductors and methods described herein can be implemented in other applications or electronic devices.

The methods disclosed herein comprise one or more actions for achieving the described method. The actions may be interchanged with one another without departing from the scope of the claims. In other words, unless a specific order of steps or actions is specified, the order and/or use of specific steps and/or actions may be modified without departing from the scope of the claims.

It is to be understood that the implementations are not limited to the precise configuration and components illustrated above. Various modifications, changes and variations may be made in the arrangement, operation and details of the methods and apparatus described above without departing from the scope of the implementations. For example, embodiments are described in which completed windings are fabricated by microfabrication prior to assembly by lamination or otherwise adhering to core portion(s) prefabricated without microfabrication techniques. However, the skilled artisan will appreciate in view of the teachings herein that portions of windings can be formed by microfabrication techniques, and the portions connected to one another to complete the windings adjacent the core using pick-and-place technology.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. Where the context permits, the word “or” in reference to a list of two or more items is intended to cover all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while the disclosed embodiments are presented in a given arrangement, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A method of manufacturing an inductive component, comprising:
providing a substrate;
forming at least a portion of one or more windings on the substrate using microfabrication techniques to form a winding structure; and
placing at least a first part of a discrete ferromagnetic core on or adjacent a first side of the at least a portion of one or more windings, wherein the first part of the discrete ferromagnetic core is prefabricated.

2. A method according to claim 1, wherein the first part of the ferromagnetic core includes a first planar section formed in a first plane, and the winding structure is completed by the microfabrication techniques prior to the placing.

3. A method according to claim 2, wherein the one or more windings are formed as planar structures substantially parallel to the first plane.

4. A method according to claim 3, wherein the first part of the ferromagnetic core further includes one or more protrusions and the first part of the ferromagnetic core is placed such that the one or more protrusions extend into or around the two or more windings.

5. A method according to claim 3, further comprising placing the winding structure on or adjacent a second part of the ferromagnetic core.

6. A method according to claim 5, wherein the second part of the ferromagnetic core includes a second planar section and the winding structure is placed such that the second planar section is substantially parallel to the first plane.

7. A method according to claim 6, further comprising connecting the one or more protrusions to the second planar structure such that that first and second parts of the ferromagnetic core form a complete ferromagnetic core.

8. A method according to claim 6, wherein the first planar section extends beyond the edges of the one or more windings, the one or more protrusions includes a first and a second protrusion, and the first planar structure is placed such that the first and second protrusions extend around the one or more windings.

9. A method according to claim 8 wherein the one or more windings are formed as planar spiral windings to form a first opening, the one or more protrusions includes a third protrusion, and the first planar section is placed such that the third protrusion extends through the first opening.

10. A method according to claim 9, wherein the third protrusion partially extends into the opening and forms a gap with the second planar section.

11. A method according to claim 1, wherein the substrate includes a layer of ferromagnetic material formed on a side opposing the side on which the one or more windings are formed, the layer of ferromagnetic material forming a second part of the ferromagnetic core.

12. A method according to claim 11, further comprising forming one or more holes in the substrate.

13. A method according to claim 1, further comprising depositing an insulating layer on the substrate, wherein the one or more windings are formed on the insulating layer.

14. A method according to claim 1, wherein the at least a first part of a ferromagnetic core is placed using a pick and place machine.

15. A method according to claim 1, wherein the one or more windings are formed using deposition.

16. A method according to claim 1, wherein the inductive component is a transformer, and the one or more windings is two or more windings.

17. A method of manufacturing an inductive component in which a winding structure is provided using microfabrication techniques and a discrete core is positioned on or around the winding structure.

18. An inductive component, comprising:
one or more windings, at least portions of which are formed using microfabrication techniques; and
a discrete ferromagnetic core positioned on or around the one or more windings.

19. An inductive component according to claim 18, wherein the discrete ferromagnetic core is made of Cobalt-Zirconium-Tantalum-Boron.

20. An inductive component according to claim 18, wherein the discrete ferromagnetic core is made of sintered ferrite.
